(19) United States
(12) Patent Application Publication
(10) Pub. No.: US 2026/0062617 A1
(43) Pub. Date: Mar. 5, 2026

(54) NONAQUEOUS SUSPENSIONS, METHODS AND SYSTEMS FOR TREATMENT OF MINERAL SLURRIES

(71) Applicant: PSMG, LLC, Milton, GA (US)

(72) Inventor: Jason K. Holt, Ball Ground, GA (US)

(21) Appl. No.: 18/821,710

(22) Filed: Aug. 30, 2024

(51) Int. Cl. C09K 23/52; C08L 33/02; C08L 33/26; C08L 97/00; C09K 23/50

(52) U.S. Cl. CPC C09K 23/52; C08L 33/02; C08L 33/26; C08L 97/005; C09K 23/50; C08L 2201/56

(57) ABSTRACT

A suspension of a water soluble anionic polymer suspended as a solid in a nonaqueous carrier fluid includes at least about 20 wt % water soluble anionic polymer and less than about 5 wt % water. The water soluble anionic polymer may be an acrylate or methacrylate based homopolymer or copolymer polymerized with an acrylamide- or styrene-based monomer. The water soluble anionic polymer may be a naturally occurring biopolymer or derivative thereof such as lignosulfonate. Mixtures of more than one polymer may be used. The nonaqueous carrier fluid may comprise or consist essentially of mineral oil and/or an alcohol, ether or acetate derivative based on ethylene glycol and/or propylene glycol. The suspension can be used for treating mineral slurries such as those generated in mining operations and generally for dispersing particles in aqueous solution.

### FIELD OF THE INVENTION

The invention relates to suspensions of polymer in a non-aqueous liquid. The suspensions are generally suitable as rheology modifiers for treating aqueous mineral slurries particularly those generated during mining operations, or as dispersants for dispersing solids in aqueous solution. The invention also relates to methods and systems suitable for treating mineral slurries in order to facilitate pumping of the slurries over long distances.

### BACKGROUND OF THE INVENTION

Many domestic minerals such as clay are mined by open-pit methods using various types of heavy machinery. The process includes removing topsoil and rocks with bulldozers or excavators to expose the mineral deposit. The mineral deposit is then dug out of the ground and sent through a pipeline as a slurry to a processing plant which can be located many miles away. The properties of the mineral slurries are adjusted depending on the particular design of the mining operation so that large volumes can be moved safely, efficiently, and cost-effectively.

As an example of the scale of these operations, the Georgia Mining Association has reported minerals extracted from Georgia mines are valued at more than $2 billion each year. Nonfuel minerals include various types of clays such as kaolin, stone, sand and gravel, barite, bauxite, gemstones, lime and mica. More than 8 million metric tons of kaolin, more than 60% of the nation's supply, is extracted from the “kaolin belt”, a line of massive deposits stretching across the state of Georgia. Kaolin is used extensively to coat and fill paper, strengthen rubber, as a component in paints and inks and in the manufacture of china, porcelain and refractories.

Polyacrylate based dispersants (PBD) are water-soluble polymers and widely used as dispersants for mineral slurries. PBD dispersant is typically applied to lower the viscosity of mineral slurries to improve pumpability and additionally to prevent liquid water separation of finished mineral suspensions. PBD is commonly available as a liquid solution with concentrations reaching close to 50% activity. PBD is also available in powder form. Most mining applications utilize liquid PBD due to the hygroscopic nature of the powder versions. Additionally, the liquid versions allow for ease of application into mineral slurry plumbing and or tanks. For the mentioned reasons, although dry PBD would reduce freight and usage costs for the vast majority of mining operations, liquid PBD is the product of choice.

The Kaolin mining industry is one of the largest consumers of PBD dispersant. Quite often, kaolin mining operations are located many miles away from the kaolin processing facilities. Kaolin mining operations typically slurry kaolin at 70%-75% by wt and pump the slurry up to 30 miles. Without dispersant addition, the kaolin slurry would be too viscous to pump such long distances.

### SUMMARY OF THE INVENTION

A suspension comprising a water soluble anionic polymer suspended as a solid in a nonaqueous carrier fluid is described. The suspension comprises at least about 20 wt % water soluble anionic polymer suspended as a solid in a non-aqueous carrier fluid, wherein the suspension comprises less than about 5 wt % water. The water soluble anionic polymer may be derived by polymerization of one or more monomers wherein at least one of the monomers is anionic or has functionality that can be converted to an anionic group after polymerization is carried out. The water soluble anionic polymer may comprise a mixture of polymers. Examples of useful water soluble anionic polymers include a homopolymer of acrylate, a homopolymer of methacrylate, a copolymer of acrylate and methacrylate, or a mixture thereof. Other examples include a copolymer of acrylate and/or methacrylate with an acrylamide or derivative thereof, or with styrene or a derivative thereof. The water soluble anionic polymer may comprise a naturally occurring biopolymer or a modified naturally occurring biopolymer such as a lignosulfonate. The water soluble anionic polymer generally has a molecular weight of less than about 50,000 g/mol, or less than about 20,000 g/mol. The nonaqueous carrier fluid may comprise or consist essentially of mineral oil and/or an alcohol, ether or acetate derivative based on ethylene glycol and/or propylene glycol.

A method of treating a mineral slurry is described and may comprise delivering the suspension to a mineral slurry to form a treated mineral slurry such that the viscosity of the slurry is reduced. The method may further comprise pumping the treated mineral slurry for many miles to a remote location.

A system for treatment of a mineral slurry is described and includes a reservoir of the suspension with a conduit connected to the reservoir and configured to deliver the suspension from the reservoir into a mineral slurry.

A method of dispersing mineral particles is described and generally comprises combining the suspension with particles and aqueous solution such that the water soluble anionic polymer disperses the particles.

### DETAILED DESCRIPTION

A convenient format has been developed for the delivery of a water soluble anionic polymer as a suspension in a nonaqueous liquid or carrier fluid, in particular a mineral oil. The suspension may be highly concentrated for efficient delivery of a water soluble anionic polymer, particularly acrylic resins, such as polyacrylate or methacrylate homopolymer, derivatives thereof, a copolymer thereof, or particularly a lignosulfonate or mixtures thereof. Due to the solubility properties of the water soluble anionic polymer and the carrier fluid, the polymer does not dissolve, substantially does not dissolve, or dissolves only to some acceptable extent in the nonaqueous carrier fluid as described below. The nonaqueous carrier fluid can suspend the water soluble anionic polymer at high concentrations, such as greater than 50 wt %, while still being deliverable. For a given viscosity, the amount of water soluble anionic polymer suspended in the nonaqueous carrier fluid can be greater than the amount dissolved in an aqueous carrier solution. As a result, the suspensions provide a convenient capability for the delivery of a polymer dispersant with a lower volume of liquid.

The water soluble anionic polymer can initially be in the form of a solid such as a powder or granular material, or at least is handleable as a solid. Suitable water soluble anionic polymers include those commonly referred to as rheology modifiers or dispersants, and they can be synthetic polymers, naturally occurring biopolymers, or synthetically modified derivatives of naturally occurring biopolymers. The suspension can include one water soluble anionic polymer or a mixture of any of those described herein.

The suspensions of the present invention offer the convenience often associated with liquid phase delivery methods employed in industrial processes, and at the same time, they provide advantages where it is desirable to deliver water soluble anionic polymers in a non-hydrated form where hydration in the presence of materials to be also dispersed in a subsequent aqueous slurry or suspension where hydration in the ultimate blend can improve efficacy as a suspension aid. For example, when used to treat mineral slurries generated in mining operations, the water soluble anionic polymer as unhydrated powder particles can dissolve such that the polymer does not pre-maturely interact and bind to minerals in a non-efficient manner thereby reducing overall dosage requirements. The suspensions can be highly concentrated without gelling which can increase the viscosity to an undesirable level. Thus, the suspensions offer advantages of using solid forms of polymer delivered in the desirable liquid format.

Handling and shipping of solids for industrial use can be problematic for many reasons including, among others, potential air quality and safety issues. These handling and safety issues can be particularly problematic at points of delivery where chemicals are delivered from suitable storage containers, generally without access to sophisticated handling equipment and highly skilled technicians. The suspensions described herein can provide both higher concentrations relative to aqueous solutions of the polymer and non-hydrated particles that may be more effective for a given amount. at one or more delivery points of a treatment operation. The ability to use the dispersions provides significantly simplified and reduced handling and safety issues. In some embodiments, the suspensions are delivered to a site near a delivery point and used “as is”. In other embodiments, the suspensions are delivered to a site and modified prior to being used. For treatment of mineral slurries, the suspensions can be metered into the slurry stream at one or more points of delivery along the stream. The treated stream can then proceed to a settling tank, settling pond or other type of structure or facility for further processing.

Water soluble anionic polymers, such as those described herein, are widely utilized for treating mineral slurries of various types. Traditionally, these polymers are available as aqueous solutions with concentrations ranging from 10% to 50% solids by weight of polymer dissolved in water. The aqueous solutions can be very viscous, especially for high molecular weight polymers, which poses challenges in handling and pumping, especially in colder climates. Associated freight costs for transporting a product comprising at least 50% water are considerable, particularly over long distances to regions like the western United States. Some water soluble anionic polymers are available as solids but they tend to be very hygroscopic and can form into gels which can complicate formulation, processing and handling.

Industrial operations, such as mining operations, are often set up for delivery of solids from an elevated platform, using dry feed hoppers to dispense it into pipelines carrying mineral slurries or other streams. This method, while effective in coal mining operations, is impractical for other mining operations such as open-pit methods which lack elevated feeder systems. Moreover, pre-mixing and dissolving chemicals onsite can negate its performance benefits, making it economically unviable. Additionally, the complexity of dry feeder systems contrasts with the simplicity of liquid versions that can be efficiently pumped from ground-level storage tanks.

To address the disadvantages of using water soluble anionic polymers as highly viscous liquids or as solids, a nonaqueous liquid suspension or dispersion of solid polymer has been developed. The suspension includes a carrier fluid selected so that the polymer does not dissolve, substantially does not dissolve, or dissolves only to some acceptable extent in the carrier fluid as described below. Since the polymer does not dissolve, the suspension can be highly concentrated in anionic water soluble polymer and can be transported efficiently and cost-effectively compared to aqueous solutions of the polymer. Additionally, because the suspension is handleable as a liquid, the use of dry feeder systems with high frequency of bag changes and higher loading can be eliminated.

As used herein, the term “polymer” refers to oligomers or polymers, and polymers include homopolymers and/or copolymers unless specified otherwise. The term “acrylic” includes alkylacrylic, particularly methacrylic, and (meth)acrylic is used to refer to acrylic and methacrylic. The term acrylic resins has sometimes been associated with this class of polymers. The term “acrylate” includes alkylacrylate, particularly methacrylate, and (meth)acrylate is used to refer to acrylate and methacrylate. These polymers are generally related to derivatives of polyacrylic acid and/or polymethacylic acid, where the carboxylic acid moieties. The term “acrylamide” refers to acrylamide and methacrylamide and (meth)acrylamide refers to both.

The particulate anionic polymers useful in the suspensions described herein may be effectively provided in small particulate form, e.g., microbeads, or in larger particulate sizes, such as granules. The particulate anionic polymers generally have an average particle diameter from about 1.0 microns to about 800 microns, in further embodiments from about 5.0 microns to about 700 microns, and in other embodiments from about 10.0 microns to about 500 microns, or from about 50 microns to about 200 microns. For particular applications, average particle diameters greater than about 30 microns or in further embodiments from about 40 microns to about 300 microns can be particularly appropriate. Particulate anionic polymers comprising beads or the like may have an average particle diameter greater than about 30 microns, from about 30 microns to about 300 microns or from about 50 microns to about 200 microns. In some embodiments, the particulate polymer can have any reasonable shape such as granular, ground flakes, mixtures thereof or the like. Particulate anionic polymers comprising any shape may have an average diameter from about 60 microns to about 150 microns. A person of ordinary skill in the art will recognize that additional ranges of average particle diameter within the explicit ranges above are contemplated and are within the present disclosure.

The suspensions described herein comprise particulate polymer in a non-aqueous liquid. In embodiments of particular interest, the liquid does not dissolve the polymer such that the polymer particles remain suspended but not dissolved into the liquid. In general, it is desirable to form high concentrations of polymer in the suspension for efficient delivery of polymer, although it can be desirable to deliver in a suspension of undissolved polymer particles at moderate concentrations. In some embodiments, the suspension can have a concentration range from a lower limit of about 25 wt %, in further embodiments about 35 wt %, in other embodiments about 40 wt %, in additional embodiments about 45 wt %, in some embodiment, about 50 wt %, and in further embodiments 51 wt % any of which to an upper limit of about 80 wt %, in further embodiments about 75 wt %, in other embodiments about 70 wt %, in additional embodiments about 65 wt %, and in further embodiments about 60 wt %. Thus, explicit ranges cover from a broadest range of about 25 wt % to about 80 wt % to a narrower range of about 51 wt % to about 60 wt %. The suspensions may also comprise additives as described below. In general, the upper limit of the concentration of the dispersions is influenced by the ability to effectively deliver the suspension. While the viscosity increases with concentration, this concentration dependent viscosity increase is slower than in an aqueous solution with dissolved polymer. While not wanting to be limited by theory, the higher viscosity in aqueous solution can be understood based on the change in morphology of polymer particles from swelling and disentanglement of polymer chains upon dissolving. A person or ordinary skill in the art will recognize that additional ranges of polymer concentration within the explicit ranges above are contemplated and are within the present disclosure.

Water soluble anionic polymers useful in the suspensions of the present invention are generally commercially available in solid, particulate form, or at least are convertible from a hydrated form or aqueous solution into a solid, particulate form, and dissolve after delivery of the suspension to some desirable extent in the slurry being treated or the solution to which they are added. The anionic polymers will likely be hygroscopic, so it may be desirable to limit the water content of the solid form depending on the particular polymer and carrier fluid and their respective amounts. Minor amounts of water absorbed from the atmosphere that do not interfere with the formation of the substantially anhydrous suspensions described herein may be acceptable, and absorbed water may be considered an irrelevant minor contaminant. Generally, the total amount of water, from the water soluble anionic polymer and/or the carrier fluid, may be less than about 5 wt % of the suspension, or from about 1 wt % to about 5 wt % of the suspension. If too much water is present, the water soluble anionic polymer will begin to hydrate and thicken the suspension. The water soluble anionic polymer can be a synthetic polymer, a naturally occurring biopolymer, or a synthetically modified derivative of a naturally occurring biopolymers, or a mixture thereof.

The water soluble anionic polymer be described as an oligomer or polymer. Generally, there is no overall definition as to whether a macromolecule is an oligomer or a polymer. Oligomers typically comprise a much smaller number of repeat units compared to polymers and their properties can be significantly dependent on chain length. The molecular weight of an oligomer is reported as number average molecular weight, Mₙ. The molecular weight of a polymer is reported as weight average molecular weight M_{w} and sometimes Mₙ is reported. As used herein, the term “polymer” includes oligomer and polymer.

The water soluble anionic polymer can have a molecular weight of at least about 250 g/mol, at least about 1000 g/mol, at least about 5000 g/mol, from about 250 g/mol to about 50,000 g/mol, from about 500 g/mol to about 20,000 g/mol, or from about 1000 g/mol to about 10,000 g/mol. A person of ordinary skill in the art will recognize that additional ranges of average molecular weights within the explicit ranges above are contemplated and are within the present disclosure.

Useful synthetic water soluble anionic polymers include homopolymers of an anionic monomer, copolymers of one or more anionic monomers, or copolymers of one or more anionic monomers polymerized with one or more nonionic monomers, especially comprising monomers of acrylic acid, esters thereof, salts thereof or combinations thereof. The anionic monomers can include monovalent anionic groups such as carboxylate and sulfonate groups. The synthetic water soluble anionic polymer may comprise anionic functionality wherein all or some of the anionic groups are associated with counterions including monovalent cations such as sodium, ammonium, lithium and potassium, or in some embodiments, the anionic functionalities or a portion thereof can be protonated, such as a polyacrylic acid or copolymer thereof. Suitable synthetic water soluble anionic polymers are those readily available in the form of a solid. Also, synthetic water soluble anionic polymers may be available as aqueous solutions wherein the polymer can be isolated as a solid such as a salt.

Particularly useful synthetic water soluble anionic polymers include homopolymers of acrylate (—(HCOO⁻—)ₙ), homopolymers of methacrylate (—(H₂CCOO⁻—)ₙ), and copolymers of acrylate and methacrylate. Homopolymers of sodium acrylate and sodium methacrylate are readily available in solid form and in a range of molecular weights. Copolymers consisting of acrylate and methacrylate are also available. The homopolymers and copolymers can have any suitable molecular weight as described above. Commercial sources of these polymers in particulate form are commercially available in industrial scales.

Useful synthetic water soluble anionic polymers also include copolymers of (meth)acrylate monomers, nonionic monomers and/or other ionic monomers functionalized with anionic groups such as carboxyl and sulfonyl. Useful nonionic monomers include ester forms of (meth)acrylate such as linear or branched alkyl (meth)acrylates or ethoxylated alkyl (meth)acrylates comprising ether or glycol linkages, hydroxyalkyl (meth)acrylates, aminoalkyl (meth)acrylates, and styrene acrylates. Useful other ionic monomers functionalized with anionic groups include carboxylate- or sulfonate-functionalized alkyl (meth)acrylates or styrene (meth)acrylates. Particularly useful synthetic water soluble anionic copolymers include copolymers of (meth)acrylate monomers, (meth)acrylamide monomers, and/or N-alkyl (meth)acrylamide monomers. Copolymers derived from at least about 50 wt % (meth)acrylate monomer and acrylamide may be preferable. The copolymers can have any suitable molecular weight as described above.

Synthetic water soluble anionic polymers can be derived from greater than about 50 wt % (meth)acrylate monomers relative to the molecular weight of the polymer. The synthetic water soluble anionic polymers can be derived from greater than about 80 wt %, greater than about 90 wt %, greater than about 95 wt %, or about 100 wt % (meth)acrylate monomers relative to the molecular weight of the polymer.

Useful synthetic water soluble anionic polymers also include homopolymers and copolymers of maleic anhydride wherein the anhydride functionality is ring-opened to form 1,2-carboxylate groups along the polymer main chain. Ring-opened poly(maleic acid) homopolymers can be used, in addition to copolymers of ring-opened maleic anhydride and styrene which are also known.

Synthetic water soluble anionic polymers are available from many different sources. Many are available from on-line suppliers such as Amazon. com, retailers such as Walmart Inc., industrial and laboratory chemical suppliers, and chemical companies such as BASF Corp. and Lubrizol Corp.

The water soluble anionic polymers useful in the suspensions of the present invention include biopolymers such as modified or unmodified corn starches, tannins, lignins or alginates. The water soluble anionic polymer may comprise a lignosulfonate. Lignosulfonates are derivatives of lignin which are derived from different chemical pulping reactions. Lignosulfonate is produced through a sulfite pulping process as a by-product in the production of cellulose. Although the exact structure of lignosulfonate has not been elucidated, it is generally accepted that lignosulfonates not only contain hydrophobic groups, such as aromatic and aliphatic groups, but also hydrophilic groups such as hydroxyl and phenolic groups, or those with anionic functionality such as carboxylate and sulfonate groups. Lignosulfonates are available from Borregaard Ligno Tech.

The water soluble anionic polymers useful in the suspensions of the present invention include mixtures of any of the above synthetic polymers, naturally occurring biopolymers, or synthetically modified derivatives of a naturally occurring biopolymers. For example, synthetic water soluble anionic polymers comprising (meth)acrylate homopolymers and copolymers can be combined with lignosulfonates. For another example, synthetic water soluble anionic polymers comprising (meth)acrylate and (meth)acrylamide copolymers can be combined with lignosulfonates in any reasonable ratios.

The suspension generally comprises a nonaqueous carrier fluid, or consists essentially of a nonaqueous carrier fluid. The nonaqueous carrier fluid is generally a liquid at room temperature and can comprise or consist essentially of a single liquid, or it can comprise a mixture of two or more blended liquids such as any of those described therein, which are generally miscible with each other or codissolved at the relevant concentrations. The nonaqueous carrier fluid can be selected based on a desired insolubility of the water soluble anionic polymer in the carrier fluid. The nonaqueous carrier fluid can be selected such that the water soluble anionic polymer does not dissolve, substantially does not dissolve, or dissolves only to some acceptable extent in the carrier fluid. In some embodiments, the water soluble anionic polymer can be soluble in the carrier fluid at less than about 1 wt %, less than about 0.5 wt %, less than about 0.2 wt %, from about 0 wt % (measurement limit) to about 1 wt %, or from about 0.01 wt % to about 0.5 wt %. A person of ordinary skill in the art will recognize that additional ranges of weight percentages within the explicit ranges above are contemplated and are within the present disclosure.

The nonaqueous carrier fluid may include a small amount of water as long as the suspension can function as desired. Generally, the total amount of water, from the water soluble anionic polymer and/or the carrier fluid, may be less than about 5 wt %, less than about 1 wt %, less than about 0.5 wt %, from about 0.01 wt % to about 5 wt % of the suspension, or from about 0.01 wt % to about 2 wt %, relative to the total weight of the suspension. If too much water is present, the water soluble anionic polymer will begin to hydrate and thicken the suspension. In some embodiments, the nonaqueous carrier fluid can include water at an amount less than about 10 wt %, less than about 5 wt %, less than about 1 wt %, or from about 0 wt % (measurement limit) to about 1 wt %. In some embodiments, the nonaqueous carrier fluid can include water at an amount from about 1 part per million (ppm) to about 10 wt %, from about 1 ppm to about 5 wt %, from about 1 ppm to about 1 wt % (about 10,000 ppm), or from about 1 ppm to about 0.1 wt % (about 1000 ppm). The water can be considered a contaminant, for example, many industrially available mineral oils described below can include up to 500 ppm of water. A person of ordinary skill in the art will recognize that additional ranges of amounts within the explicit ranges above are contemplated and are within the present disclosure.

The nonaqueous carrier fluid can be immiscible with water, substantially immiscible with water or partly immiscible with water.

It is generally desirable for the nonaqueous carrier fluid to be compatible with the slurry, stream, solution, etc. being treated. Compatibility may be defined by quality standards, specifications, regulatory requirements or other requirements referred to as end product requirements.

The nonaqueous carrier fluid can comprise mineral oil, or it can consist essentially of mineral oil. Mineral oils are generally not a single substance but are composed of a mixture of hydrocarbons isolated from crude petroleum oil. Mineral oils comprise three main types of compounds: saturated paraffins, naphthenes and aromatics. Paraffins, such as octane and 2-methyl heptane, are linear and branched hydrocarbons that include only single carbon-carbon bonds. Napthenes, such as cyclohexane and decalin, include cyclic aliphatic hydrocarbons having only single carbon-carbon bonds. Aromatics, such as toluene and 3,4-benzopyrene, include mono- or multicyclic unsaturated hydrocarbons having carbon-carbon double bonds.

Suitable mineral oils include those obtained from a mineral source such as petroleum. Petroleum mineral oil can be manufactured from crude oils by vacuum distillation or the like to produce several distillates and a residual oil. The residual oil can be further refined to reduce levels of aromatics. Any mineral oil can be used to prepare the suspensions described herein as long as the suspension can function as desired. For a general listing of synonyms, tradenames and CAS Registry Numbers, see the compound summary available from the U.S. National Library of Medicine, PubChem Reference Collection SID 482026796, available Jun. 8, 2023, (pubchem.ncbi.nlm.nih.gov), incorporated herein by reference. Other suitable mineral oils are used in agriculture such as for livestock; see compilation by Savan Group entitled “Mineral Oil-Technical Report-2021”, Mar. 26, 2021, available at www.ams.usda.gov, incorporated herein by reference.

While any suitable mineral oil can be used, preferable mineral oils have contaminant levels that meet regulations in a jurisdiction. Suitable mineral oils have appropriately low contaminant levels of benzene, toluene, ethylbenzene and xylenes. In some embodiments, the suspension comprises less than about 5 wt % combined amounts of benzene, toluene, ethylbenzene, xylene or xylene derivatives. In some embodiments, the suspension comprises from about 0 wt % to less than about 5 wt % combined amounts of benzene, toluene, ethylbenzene, xylene or xylene derivatives. A person of ordinary skill in the art will recognize that additional ranges of contaminant levels within the explicit ranges above are contemplated and are within the present disclosure.

Suitable mineral oils can be classified by physical properties such as viscosity (kinematic viscosity). Suitable nonaqueous carrier fluids are liquid at room temperature. The mineral oil may have a viscosity, when measured at 25° C., from about 2 cP to about 1000 cP, from about 2 cP to about 500 cP, from about 5 cP to about 300 cP, from about 7 cP to about 200 cP, or from about 10 cP to about 100 cP. A person of ordinary skill in the art will recognize that additional ranges of viscosities within the explicit ranges above are contemplated and are within the present disclosure. The viscosity may be targeted within a particular range which can depend upon the method or equipment used to deliver the suspension as described below. For example, the carrier fluid may need to have a viscosity within a particular range depending on the type of pump being used in a treatment operation.

Suitable mineral oils can have a density less than that of water, for example, less than 0.98 g/mL, less than 0.95 g/mL, or from about 0.8 g/mL to about 0.95 g/mL, at room temperature.

The mineral oil can be a refined or highly refined product depending on the particular grade selected for use. Suitable mineral oils include those that are transparent liquids which may be colorless or colored. Exemplary mineral oils include white mineral oil (CAS 64742-47-8), light mineral oil or food grade mineral oil (CAS 8042-47-5), food grade white oil (CAS 92062-35-6), or heavy mineral oil (CAS 8012-95-1). Other suitable mineral oils are identified in the references cited above such as the Pubchem Reference Collection SID 482026796 and the Technical Report available at the USDA website.

The nonaqueous carrier fluid can comprise or consist essentially of any nonaqueous liquids as long as the suspension can function as desired. As described above, it is generally desirable for the suspension to be stable, especially with respect to thickening or gelling, which can cause the viscosity of the suspension to increase to some unacceptable level. It is desirable to select the carrier fluid such that the suspension does not thicken or gel.

The nonaqueous carrier fluid can comprise a water miscible or water soluble alcohol having one or more hydroxyl groups, or it can consist essentially of a water miscible or water soluble alcohol having one or more hydroxyl groups. Suitable water miscible or water soluble alcohols include monofunctional alcohols based on ethylene glycol and/or propylene glycol, for example, ethylene glycol monomethyl ether, ethylene glycol monoethyl ether, ethylene glycol monopropyl ether, ethylene glycol monoisopropyl ether, ethylene glycol monobutyl ether, ethylene glycol monophenyl ether, and ethylene glycol monobenzyl ether. Other suitable water miscible or water soluble alcohols include monofunctional alcohols with C₁-C₅ alkyl groups such as methanol, i-propanol and the like.

Suitable water miscible or water soluble alcohols include di-and trifunctional alcohols such as ethylene glycol, propylene glycol and/or glycerol, and/or any derivatives thereof. Example include 1,2-propylene glycol, 1,3-propylene glycol, butyl diglycol, glycerolethylene glycol, propylene glycol, trimethylene glycol, 1,2-butylene glycol, 1,3-butylene glycol, 1,4-butylene glycol, tetramethylene glycol, 2,3-butylene glycol, pentamethylene glycol, 2-butene-1,4-diol, hexylene glycol, octylene glycol; trihydric alcohols such as glycerine, trimethylol propane, 1,2,6-hexanetriol and the like; tetrahydric alcohols such as penthaerythritol; pentahydric alcohols such as xylytol, etc.; and hexahydric alcohols such as sorbitol, mannitol.

The nonaqueous carrier fluid can comprise a water miscible or water soluble ether based on ethylene glycol and/or propylene glycol such as ethylene glycol dimethyl ether, ethylene glycol diethyl ether, ethylene glycol dibutyl ether, propylene glycol dimethyl ether, propylene glycol diethyl ether and propylene glycol dibutyl ether.

The nonaqueous carrier fluid can comprise a water miscible or water soluble acetate ester based on ethylene glycol and/or propylene glycol such as ethylene glycol monomethyl ether acetate, ethylene glycol monoethyl ether acetate, ethylene glycol monobutyl ether acetate, and ethylene glycol monophenyl ether acetate.

Due to the dispersion of the insoluble polymer particles, the polymer concentration can be greater without an unacceptably high viscosity, which would render the dispersion unsuitable for pumping into the flow. At the same time, the solubilization of the polymer in the presence of the minerals may improve the flow properties of the minerals for a particular weight of polymer. The suspension can be used as a rheology modifier and/or dispersant for lowering viscosity, reducing friction, facilitating coating, or reducing caking or clogging of equipment. The suspension can also be used as a dispersant to prevent settling of solids in various liquids, facilitate dispersing of solids in liquids and for separation of solids. In many cases, the suspension can be used for treatment of aqueous or nonaqueous flows.

The suspension can be used in a variety of industries and products. The suspension can be used in mining operations including surface mining methods such as with open-pit mining, hydraulic mining and dredging, or in underground mining methods in which water is used for processing, transporting, managing waste, and other steps depending on the particular mining method. Use of the suspension in the surface mining of minerals is described below. The suspension can be particularly useful in kaolin mining operations which are one of the largest consumers of water soluble anionic polymers.

The suspension can be used in the paper industry for manufacture and processing of pulp and paper, as a vehicle for transporting fibers and other components in paper machines, fiber dewatering, paper processing, paper sheet formation, managing waste and other steps depending on the process. The suspension can also be used to formulate paints and inks, and to formulate coating solutions used to coat various substrates used for food, construction, electronics and so forth. The suspension can also be used in the water and wastewater industries such as for clarification, separation of solids, transport of impurities and so forth. U.S. Pat. No. 10,494,523 B2 to Holt, entitled “Particle Suspensions of Flocculating Polymer Powders and Powder Flocculant Polymer Blends,” incorporated herein by reference, describes use of polymer blends suspended in aqueous liquids for treating waste streams and reservoirs to remove contaminants, and for papermaking to aid fiber retention. In some embodiments, the suspended polymer blends may form flocs which may or may not be the case for the suspensions described herein.

The suspension can be used in mining operations used to mine minerals such as different types of clay including kaolin and fuller's earth, stone, silt, sand and gravel, barite, bauxite, titanium dioxide, silica, magnesium silicate, various gemstones, metals such as iron oxide, lime and mica. The U.S. Bureau of Mines defines clay as a natural, earthy, fine-grained material, largely of a group of crystalline hydrous silicate minerals known as clay minerals. Clays can be categorized into six groups: kaolin, ball clay, fire clay, bentonite, fuller's earth and common clay and shale. Kaolin, or china clay, is defined as a white, claylike material composed mainly of kaolinite, which is a hydrated aluminum silicate (Al₂O₃·2SiO₂·2H₂O) and other kaolin-group minerals. In its natural state, kaolin is a white, soft powder consisting principally of the mineral kaolinite, which, under the electron microscope, is seen to consist of roughly hexagonal, platy crystals. In addition, crude kaolin is frequently stained yellow by iron hydroxide pigments. It is often necessary to bleach the clay chemically, to remove the iron pigment and to wash it with water to remove the other minerals in order to prepare kaolin for commercial use.

Mineral deposits are extracted from the earth and as solids, and the solids are formed into slurries which are then transported through established pipelines to mineral processing plants. For many different mining operations, it can be desirable for the mineral slurries to be highly concentrated in solids so that the solids can be transported efficiently and cost-effectively, with minimal wear and tear on equipment and infrastructure. This can be very challenging given that the mineral slurries tend to be very viscous at 70 to 75 wt % and need to be transported for many miles, for example, 30 miles, before reaching a mineral processing plant.

The polymers can be used to modify the rheology of a mineral slurry, for example, by lowering its viscosity with minimal decrease or no decrease in concentration of the solids. Properties to be evaluated include those which are used to calculate pipeline frictional losses according to known mathematical models. Examples include shear rate within a pipe of a given diameter and for a given flow rate. Shear stress can also be calculated according to known mathematical models. The polymer suspension can be added to mineral slurries at any one or more locations along the pipeline, for example, the polymer suspension can be added to a reservoir of mineral slurry before pumping commences, or before a flotation process used to separate solids.

The anionic polymers can be used as a flotation aid to facilitate separation of components. For mineral processing, the anionic polymers, which can be provided as the concentrated dispersions, can be added before flotation is carried out in order to facilitate liberation of mineral particles for separation. The anionic polymers can be used as a flotation aid to purify sand by removal of weak magnetic iron as well as aluminum oxide, mica and other non-magnetic minerals, or it can be used to remove impurities such as silica.

The suspension can be used to facilitate separation of components such as contaminants from wastewater or waste streams. Mines generally produce flow of relatively dilute waste streams with tailings, also referred to as mineral slimes. The waste streams produced by mining operations often include clay, claylike waste or other silicate or metal oxide particulate waste. The suspensions can be injected into a waste stream containing suspended contaminants that is then directed to a settling tank.

In some embodiments, the suspensions can be added in part early in the waste flow with optional additional portions added along the flow. In some embodiments, the suspensions can be added essentially at or near the point of entry of the waste flow into a settling tank. Proper incorporation or mixing of the suspension into the waste stream facilitates this earlier delivery without interfering with the desirable flow of the waste stream through conduits leading to a settling tank.

If the suspensions are delivered in a water dilution flow, the degree of dissolving of the water soluble anionic polymer can be controlled to yield a desired state of the polymer when delivered into the waste stream. An earlier delivery of the suspensions can result in improved mixing within the waste flow, which can result in the reduced use of suspension while improving the effectiveness of the water soluble anionic polymer in its solid form. In particular, in some embodiments, a suspension can be added at least 10 meters upstream from a port, e.g., central inlet, into a settling tank. When delivered in a water dilution flow, any reasonable water source can be used to generate the flow.

The suspension can be used in place of water soluble anionic polymer, either as an aqueous solution or as a solid, to disperse solids in aqueous solution. Solids which can be dispersed include many minerals such as titanium dioxide, silica, colored pigments and solids used in the preparation of wallboard/sheetrock and ceramics.

The suspension can be used to redisperse solids collected during different processes. Mineral slurries are often subjected to many processing steps before a commercially useable mineral is obtained. For example, crude kaolin is typically processed to remove naturally coexisting materials, particularly ferric iron oxides. Iron (III) oxide, hydroxide and hydrated oxide are present in crude kaolin with as little as 0.4 weight % being enough for the kaolin to appear yellow/pink/red or rust colored. Aqueous kaolin slurries can be treated with acid such as alum to a pH less than 3 to solubilize the ferric iron oxides. The acidified aqueous portion can then be separated from the kaolin using methods such as vacuum filtering or dewatering. Once dewatered, the kaolin filter cake can be redispersed using the suspension.

The suspension can be used in processes in which settled solid waste that collects in a thickener tank needs to be dispersed. Often the settled solid waste is removed from the thickener tank by pumping slurries of the waste away from an operation. For many mining operations, the waste slurries need to be pumped away over long distances and/or up steep elevation to some area where tailings are impounded.

Polymeric suspensions used to treat slurries and wastewaster are known. U.S. patent application Ser. No. 18/744,205 to Holt, entitled “Nonaqueous Suspensions, Methods and Systems for Treatment of Wastewater,” incorporated herein by reference, describes use of mineral oil-based suspensions including particulate polydiallyldimethylammonium chloride (polyDADMAC) for treating wastewater. U.S. Patent '523 to Holt cited above describes use of suspended blends of polyethylene oxides, polyDADMAC, polyacrylamides and DADMAC acrylamide copolymers. U.S. Pat. No. 5,698,109 to Payne et al., entitled “Purification of Aqueous Liquor,” incorporated herein by reference, describes addition of particulate polymers directly into waste streams. U.S. Pat. No. 5,112,500 to Jones, entitled “Purification of Aqueous Liquor,” incorporated herein by reference, describes addition of polyDADMAC solution. European U.S. Pat. No. 536,194 B1 to Payne et al., entitled “Purification of Aqueous Liquor,” incorporated herein by reference, describes the desirability of delivery of particulate polyDADMAC into a wastewater flow. The present application is directed to effective and efficient ability to deliver anionic polymers for a range of application areas.

Polymeric suspensions used for other applications such as hydraulic fracture are also known. U.S. Patent Application Publication No. US 2023/0130401 A1 to Holt, entitled “Liquid Chloride Salt-Based Polymer Suspension Fluids With Polyethylene Glycol Dispersants and Application to Drag Reduction,” incorporated herein by reference, describes aqueous carrier fluids comprising chlorides, such as calcium chloride, wherein the chlorides are present in amounts such that polyethylene glycol powders can be suspended in the carrier fluid. U.S. Patent Application Publication No. US 2023/0126451 A1 to Holt, entitled “Liquid Chloride Salt-Based Polymer Suspension Fluids With Polyethylene Glycol Dispersants and Application to Drag Reduction,” incorporated herein by reference, describes aqueous carrier fluids comprising chlorides, such as calcium chloride, wherein the chlorides are present in amounts such that polyethylene glycol powders can be suspended in the carrier fluid.

The suspensions generally can comprise at least about 10 wt %, at least about 20 wt %, at least about 25 wt %, at least about 30 wt %, no more than about 85 wt %, from about 10 wt % to about 80 wt %, from about 15 wt % to about 75 wt %, from about 20 wt % to about 70 wt %, or from about 50 wt % to about 70 wt % polymer relative to the total weight of the suspension. A person of ordinary skill in the art will recognize that additional minimum weight percentages and additional ranges of weight percentages, within those recited here, are contemplated and are within the present disclosure.

For a suspension comprising or consisting essentially of mineral oil as a carrier fluid, the suspension can comprise at least about 10 wt %, at least about 20 wt %, at least about 25 wt %, at least about 30 wt %, no more than about 85 wt %, from about 10 wt % to about 80 wt %, from about 15 wt % to about 75 wt %, from about 20 wt % to about 70 wt %, or from about 50 wt % to about 70 wt % polymer relative to the total weight of the suspension. A person of ordinary skill in the art will recognize that additional minimum weight percentages and additional ranges of weight percentages, within those recited here, are contemplated and are within the present disclosure.

For a suspension comprising or consisting essentially of monofunctional alcohols based on ethylene glycol and/or propylene glycol as a carrier fluid, the suspension can comprise at least about 10 wt %, at least about 20 wt %, at least about 25 wt %, at least about 30 wt %, no more than about 85 wt %, from about 10 wt % to about 80 wt %, from about 15 wt % to about 75 wt %, from about 20 wt % to about 70 wt %, or from about 50 wt % to about 70 wt % polymer relative to the total weight of the suspension. A person of ordinary skill in the art will recognize that additional minimum weight percentages and additional ranges of weight percentages, within those recited here, are contemplated and are within the present disclosure.

For a suspension comprising or consisting essentially of ethers and/or acetates based on ethylene glycol and/or propylene glycol as a carrier fluid, the suspension can comprise at least about 10 wt %, at least about 20 wt %, at least about 25 wt %, at least about 30 wt %, no more than about 85 wt %, from about 10 wt % to about 80 wt %, from about 15 wt % to about 75 wt %, from about 20 wt % to about 70 wt %, or from about 50 wt % to about 70 wt % polymer relative to the total weight of the suspension. A person of ordinary skill in the art will recognize that additional minimum weight percentages and additional ranges of weight percentages, within those recited here, are contemplated and are within the present disclosure.

In some embodiments, the suspension is substantially free of water and has a freeze point and good flowability below 0° C. (32° C.).

The viscosity of the suspension can be within a particular range which can depend upon the method or equipment used to deliver the suspension. For example, the carrier fluid may need to have a viscosity within a particular range depending on the type of pump being used in a treatment operation. Useful pumps include those that push the treated water forward such as those including a worm gear with poly stator. Progressing cavity pumps may be used such as a CP Model pump available Continental Pump Co. or a Moyno™ pump available from Moyno, Inc. Gear, piston or diaphragm pumps can be used but may clog due to one way check valves and low tolerance flow zones that will allow the suspension to pass but essentially filter out the solid polymer. The suspension may have a viscosity, when measured at 25° C., from about 2 cP to about 1500 cP, from about 2 cP to about 1000 cP, from about 2 cP to about 500 cP, from about 5 cP to about 300 cP, from about 7 cP to about 200 cP, from about 10 cP to about 100 cP, or from about 300 cP to about 700 cP. The viscosity of the suspension may or may not be largely determined by the viscosity of the carrier fluid. A person of ordinary skill in the art will recognize that additional ranges of viscosities within the explicit ranges above are contemplated and are within the present disclosure.

While the suspensions can consist essentially of water soluble anionic polymer and nonaqueous carrier fluid, minor components or additives can be included in the suspensions for various reasons such as to modify the properties of the suspension, such as suspension aids, coloring agents, viscosity modifiers, surfactants, or the like. The minor components or additives may be liquids or particles that may or may not dissolve in the nonaqueous carrier fluid. Clay particles are an example of a suspension aid that may be included in the suspensions. The minor components, if used, are generally in amounts of no more than about 5 wt % each and no more than about 15 wt % total. The minor components do not change the fundamental nature of the suspension with respect to maintaining flowability and insolubility of the water soluble anionic polymer.

To achieve the desired purpose of the suspension embodiments, the suspensions do not need to be stable and as a general matter may not be, although it is not problematic if the suspensions are coincidently stable. Stability in this context is intended to mean that a well mixed suspension remains homogenous. In general, the suspensions separate with the solids concentrating toward the bottom of a container due to gravity. However, the suspensions can be mixed to form homogenous suspensions when desired, such as for delivery for a particular application as described above.

The suspensions may be used with or without modification. Generally, the suspensions can be modified as long as the suspension can be used as desired. In some embodiments, the suspensions may be modified by adding additional components. In other embodiments, the suspensions may be diluted with a liquid such as a nonaqueous liquid, which may or may not be the same or similar carrier fluid. If the suspensions are to be pumped and/or metered into water to be treated, properties such as viscosity may need to be within a particular range depending on the equipment being used. In some embodiments, the suspensions can be delivered from a suitable mixer to provide for delivery of a uniform composition, generally in selected metered amounts, and delivered into a container for dilution with water shortly prior to delivery into the waste stream.

Suspensions can be prepared with polyacrylate in dry powder form added to mineral oil.

Suspensions of polyacrylate in dry powder form added to mineral oil were prepared at about 50 wt % to about 70 wt %, for example 60 wt %, relative to the total weight of the suspension. The suspensions exhibited superior flowability with viscosities of about 1500 cP or less. For the suspension including polyacrylate in dry powder form at 70 wt %, flowability was better and viscosity was lower compared to a commercially available aqueous solution of polyacrylate at about 47 wt % to 50 wt % dissolved in water.

The 70 wt % suspension was delivered to an open-pit mining operation located in the state of Georgia. The 70 wt % suspension was pumped using a progressing cavity pump such as a CP Model pump available Continental Pump Co. or a Moyno™ pump available from Moyno, Inc.

### Further Inventive Concepts

1. A suspension comprising nonaqueous carrier fluid and at least about 20 wt % water soluble anionic polymer.
2. The suspension of claim 1 wherein the water soluble anionic polymer comprises particles.
3. The suspension of claim 1 or 2 wherein the water soluble anionic polymer comprises a homopolymer of acrylate, a homopolymer of methacrylate, or a copolymer of acrylate and methacrylate.
4. The suspension of claim 1 or 2 wherein the water soluble anionic polymer comprises acrylate and/or methacrylate copolymerized with at least one other monomer.
5. The suspension of claim 4 wherein the at least one other monomer is non-ionic and comprises an acrylate ester and/or a methacrylate ester.
6. The suspension of claim 4 wherein the at least one other monomer comprises an acrylate ester comprising anionic functionality and/or a methacrylate ester comprising anionic functionality.
7. The suspension of claim 4 wherein the at least one other monomer comprises styrene and/or a styrene derivative wherein the phenyl group is substituted with an alkyl group comprising anionic functionality.
8. The suspension of claim 4 wherein the at least one other monomer comprises acrylamide, methacrylamide, or a combination thereof.
9. The suspension of claim 4 wherein the at least one other monomer comprises acrylamide, methacrylamide, N-alkyl acrylamide, N,N-dialkyl acrylamide, N-alkyl methacrylamide, N,N-dialkyl methacrylamide, or a combination thereof.
10. The suspension of claim 9 wherein at least one of the N-alkyl acrylamide, the N,N-dialkyl acrylamide, the N-alkyl methacrylamide, or the N,N-dialkyl methacrylamide comprises an N-alkyl group comprising an anionic functionality.
11. The suspension of claim 1 or 2 wherein the water soluble anionic polymer comprises a naturally occurring biopolymer or a derivative thereof.
12. The suspension of claim 1 or 2 wherein the water soluble anionic polymer comprises lignosulfonate.
13. The suspension of claim 12 wherein the water soluble anionic polymer further comprises a homopolymer of acrylate, a homopolymer of methacrylate, or a copolymer of acrylate and methacrylate.
14. The suspension of claim 12 wherein the water soluble anionic polymer further comprises acrylate and/or methacrylate copolymerized with a non-ionic acrylate ester, a non-ionic methacrylate ester, an acrylate ester comprising anionic functionality, a methacrylate ester comprising anionic functionality, or a combination thereof.
15. The suspension of claim 12 wherein the water soluble anionic polymer further comprises acrylate and/or methacrylate copolymerized with acrylamide, methacrylamide, N-alkyl acrylamide, N,N-dialkyl acrylamide, N-alkyl methacrylamide, N,N-dialkyl methacrylamide, or a combination thereof.
16. The suspension of claim 1 or 2 wherein the water soluble anionic polymer has a molecular weight from about 1000 g/mol to about 50,000 g/mol.
17. The suspension of claim 1 or 2 comprising from about 20 wt % to about 75 wt % water soluble anionic polymer.
18. The suspension of claim 1 or 2 comprising from about 40 wt % to about 75 wt % water soluble anionic polymer.
19. The suspension of claim 1 or 2 wherein the nonaqueous carrier fluid comprises mineral oil.
20. The suspension of claim 19 wherein the mineral oil has a viscosity of less than about 200 cP at 25° C.
21. The suspension of claim 1 or 2 wherein the nonaqueous carrier fluid a monofunctional alcohol based on ethylene glycol and/or propylene glycol, or an ether based on ethylene glycol and/or propylene glycol, or a combination thereof.
22. The suspension of claim 1 or 2 wherein the suspension comprises less than about 5 wt % combined amounts of benzene, toluene, ethylbenzene, xylene or xylene derivatives.
23. The suspension of claim 1 or 2 wherein the suspension has a freeze point below 0° C.
24. A method of treating a mineral slurry, the method comprising:
   delivering a suspension to a mineral slurry thereby forming a treated mineral slurry, wherein the suspension comprises nonaqueous carrier fluid and at least about 20 wt % water soluble anionic polymer, and the treated mineral slurry has a viscosity less than that of the mineral slurry.
25. The method of claim 24, wherein the suspension comprises at least about 40 wt % water soluble anionic polymer, and the water soluble anionic polymer comprises a homopolymer of acrylate, a homopolymer of methacrylate, or a copolymer of acrylate and methacrylate.
26. The method of claim 24 or 25, the method further comprising:
   pumping the treated mineral slurry to a remote location.
27. The method of claim 24 or 25, wherein the treated mineral slurry comprises kaolin.
28. The method of claim 24 or 25, wherein the mineral slurry comprises a reservoir of settled particles.
29. A dispersion comprising a mixture one or more particulate minerals and a suspension comprising nonaqueous carrier fluid and at least about 20 wt % water soluble anionic polymer,
30. The dispersion of claim 29 wherein the one or more particulate minerals comprises titanium dioxide.

The embodiments above are intended to be illustrative and not limiting. Additional embodiments are within the claims. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein. To the extent that specific structures, compositions and/or processes are described herein with components, elements, ingredients or other partitions, it is to be understand that the disclosure herein covers the specific embodiments, embodiments comprising the specific components, elements, ingredients, other partitions or combinations thereof as well as embodiments consisting essentially of such specific components, ingredients or other partitions or combinations thereof that can include additional features that do not change the fundamental nature of the subject matter, as suggested in the discussion, unless otherwise specifically indicated. The use of the term “about” herein refers to measurement error for the particular parameter unless explicitly indicated otherwise.

What is claimed is:

1. A suspension comprising at least about 20 wt % water soluble anionic polymer suspended as a solid in a non-aqueous carrier fluid, wherein the suspension comprises less than about 5 wt % water.

2. The suspension of claim 1 wherein the water soluble anionic polymer comprises one or more of a homopolymer of acrylate, a homopolymer of methacrylate, or a copolymer of acrylate and methacrylate.

3. The suspension of claim 1 wherein the water soluble anionic polymer consists essentially of a homopolymer of acrylate, a homopolymer of methacrylate, a copolymer of acrylate and methacrylate, or a mixture thereof.

4. The suspension of claim 1 wherein the water soluble anionic polymer comprises a copolymer of monomers, the monomers comprising acrylate and/or methacrylate.

5. The suspension of claim 1 wherein the water soluble anionic polymer comprises a copolymer of monomers, the monomers comprising more than one of (meth)acrylate and (meth)acrylamide.

6. The suspension of claim 1 wherein the water soluble anionic polymer comprises a copolymer of monomers, the monomers comprising one or more of (meth)acrylate, styrene and a derivative of styrene.

7. The suspension of claim 3 wherein the water soluble anionic polymer has a molecular weight from about 250 g/mol to about 50,000 g/mol.

8. The suspension of claim 4 wherein the water soluble anionic polymer has a molecular weight from about 250 g/mol to about 50,000 g/mol.

9. The suspension of claim 1 wherein the water soluble anionic polymer comprises a lignin.

10. The suspension of claim 4 wherein the water soluble anionic polymer wherein the water soluble anionic polymer comprises a copolymer of monomers, the monomers comprising acrylate and/or methacrylate, and a naturally occurring biopolymer or a derivative thereof.

11. The suspension of claim 4 wherein the water soluble anionic polymer wherein the water soluble anionic polymer comprises a copolymer of monomers, the monomers comprising acrylate and/or methacrylate, and a lignin or a derivative thereof.

12. The suspension of claim 1 wherein the suspension comprises less than about 5 wt % water.

13. The suspension of claim 1 wherein the carrier fluid comprises mineral oil.

14. The suspension of claim 1 wherein the carrier fluid consists essentially of mineral oil and the polymer is not dissolved.

15. The suspension of claim 1 wherein the carrier fluid comprises an alcohol, ether or acetate derivative of ethylene glycol and/or propylene glycol.

16. The suspension of claim 1 wherein the suspension comprises at least about 30 wt % water soluble anionic polymer.

17. The suspension of claim 1 wherein the suspension consists essentially of the water soluble anionic polymer and the carrier fluid.

18. A method of treating a mineral slurry, the method comprising:
delivering a suspension to a mineral slurry, wherein the suspension comprises at least about 20 wt % water soluble anionic polymer suspended as a solid in a carrier fluid comprising less than about 10 wt % water.

19. The method of claim 18 wherein the water soluble anionic polymer solubilizes in the mineral slurry to form a treated mineral slurry having a viscosity less than that of the mineral slurry.

20. The method of claim 19 further comprising pumping the treated mineral slurry to a remote location at least 10 miles from the location where the treated mineral slurry is formed.

21. A system for treatment of a mineral slurry, the system comprising:
a reservoir holding a suspension comprising at least about 20 wt % water soluble anionic polymer suspended as a solid in a carrier fluid comprising less than about 10 wt % water; and
a conduit connected to the reservoir and configured to deliver the suspension from the reservoir into a mineral slurry.

22. The system of claim 21 wherein the mineral slurry originates from coal mining or mineral mining.

23. A method of dispersing mineral particles, the method comprising:
combining mineral particles and a suspension, wherein the suspension comprises at least about 20 wt % water soluble anionic polymer suspended as a solid in a carrier fluid comprising less than about 10 wt % water.
